(19) United States
(12) Patent Application Publication
(10) Pub. No.: US 2014/0167616 A1
(43) Pub. Date: Jun. 19, 2014

(54) AUTOMATIC MODE ADJUSTMENT TECHNIQUES FOR A LIGHT FIXTURE IN A LIGHTING SYSTEM

(71) Applicant: NII NORTHERN INTERNATIONAL, INC., Markham (CA)

(72) Inventors: Ahmed Zekkour, Dollard-des-Ormeaux (CA); Frederic Boyucher, Lemoyne (CA)

(73) Assignee: NII NORTHERN INTERNATIONAL, INC., Markham (CA)

(21) Appl. No.: 13/713,639

(22) Filed: Dec. 13, 2012

(51) Int. Cl. H05B 37/02

(52) U.S. Cl. CPC H05B 37/02
USPC 315/127

(57) ABSTRACT

According to techniques of the application, a method for operating a light fixture in a lighting system may include operating the light fixture in a first mode if a voltage is being supplied to the light fixture. The method may further include, while operating the light fixture in the first mode, detecting whether there has been an interruption in the voltage supplied to the light fixture. The method may further include, if there has been an interruption in the voltage supplied to the light fixture, operating the light fixture in a second mode. The first mode may include an independent timer mode and the second mode may include a synchronized timer mode.

### CROSS REFERENCE TO RELATED APPLICATIONS

[Not Applicable]

### FEDERALLY SPONSORED RESEARCH OR DEVELOPMENT

[Not Applicable]

### JOINT RESEARCH AGREEMENT

[Not Applicable]

### SEQUENCE LISTING

[Not Applicable]

### BACKGROUND OF THE APPLICATION

Generally, this application relates to lighting systems, and in particular, to light fixtures that detect whether a lighting system contains a photodetector.

Outdoor lighting systems may or may not include a photodetector with a switch (for simplicity, a “photodetector”). If a lighting system has a photodetector, light fixtures may be switched on when the photodetector detects a lower level of ambient light (for example, at dusk). The light fixtures may be switched off when the photodetector detects a higher level of ambient light (for example, at dawn).

Timers in the light fixtures may also be implemented to switch the lights on and off. In a first example, a light fixture may implement a 24-hour timer to periodically turn the light fixture on and off at particular intervals. In a second example, the light fixture may automatically turn off after a timed period. When paired with a photodetector, such a light fixture may turn on for several hours after dusk and then turn off.

These two examples are not necessarily compatible. A light fixture that implements a 24-hour repeating timer may function in an undesirable manner when placed in a lighting system in which the light fixture is periodically turned on and off by a photodetector. Conversely, a light fixture that does not implement a 24-hour repeating timer may not turn back on if a photodetector is not present in the lighting system.

Consequently, it may be desirable to automatically adjust the operation of a light fixture based on whether or not a photodetector is present in the lighting system.

### BRIEF SUMMARY OF THE APPLICATION

According to techniques of the application, a method for operating a light fixture in a lighting system may include operating the light fixture in a first mode if a voltage is being supplied to the light fixture. The method may further include, while operating the light fixture in the first mode, detecting whether there has been an interruption in the voltage supplied to the light fixture. The method may further include, if there has been an interruption in the voltage supplied to the light fixture, operating the light fixture in a second mode. The first mode may include an independent timer mode and the second mode may include a synchronized timer mode.

The independent timer mode may implement a 24-hour repeating timer such that a voltage is supplied to a lamp socket in the light fixture for a first period of time and a voltage is not supplied to the lamp socket for a second period of time. The first period of time may be of lesser duration (for example, 5 hours) than the second period of time (for example, 19 hours).

The synchronized timer mode may implement a non-repeating timer such that a voltage is supplied to a lamp socket in the light fixture for a first period of time and a voltage is not supplied to the lamp socket after the first period of time expires. The first period of time (for example, 5 hours) may begin shortly after a voltage supplied to the light fixture is turned on.

According to techniques of the application, a light fixture may include a control portion configured to operate the light fixture in a first mode if a voltage is being supplied to the control portion. The control portion may be further configured to detect whether there has been an interruption in the voltage supplied to the control portion while operating the light fixture in the first mode. If there has been an interruption in the voltage supplied to the control portion, the control portion may be further configured to operate the light fixture in a second mode. The first mode may include an independent timer mode and the second mode may include a synchronized timer mode.

The light fixture may further include a lamp. The control portion may be further configured to supply a voltage to the lamp. The independent timer mode may implement a 24-hour repeating timer such that the control portion supplies a voltage to the lamp for a first period of time and does not supply a voltage to the lamp for a second period of time. The first period of time may be of lesser duration (for example, 5 hours) than the second period of time (for example, 19 hours).

The synchronized timer mode may implement a non-repeating timer such that a voltage is supplied to a lamp in the light fixture for a first period of time and a voltage is not supplied to the lamp after the first period of time expires. The first period of time (for example, 5 hours) may begin shortly after a voltage supplied to the light fixture is turned on.

The light fixture may include a user interface, which is configured to receive an input. The control portion may be configured to receive the input from the user interface and responsively operate the lamp in the first or second mode, depending on the nature of the input.

According to techniques of the application, a light fixture may include a lamp and a control portion, which may be configured to operate the lamp in a first mode if a voltage is being supplied to the control portion. While operating the lamp in the first mode, the control portion may be configured to detect whether there has been an interruption in the voltage supplied to the control portion, If there has been an interruption in the voltage supplied to the control portion, the control portion may be configured to operate the lamp in a second mode. The first mode may include an independent timer mode and the second mode may include a synchronized timer mode.

The independent timer mode may implement a 24-hour repeating timer such that a voltage is supplied to a lamp in the light fixture for a first period of time and a voltage is not supplied to the lamp for a second period of time. The first period of time may be of lesser duration (for example, 5 hours) than the second period of time (for example, 19 hours).

The synchronized timer mode may implement a non-repeating timer such that a voltage is supplied to a lamp in the light fixture for a first period of time and a voltage is not supplied to the lamp after the first period of time expires. The first period of time (for example, 5 hours) may begin shortly after a voltage supplied to the light fixture is turned on.

The light fixture may include a user interface, which is configured to receive an input. The control portion may be configured to receive the input from the user interface and responsively operate the lamp in the first or second mode, depending on the nature of the input.

### BRIEF DESCRIPTION OF SEVERAL VIEWS OF THE DRAWINGS

FIGS. 1A and 1B respectively illustrate a lighting system and a light fixture a part thereof, according to techniques of the present application.

FIG. 2 illustrates a flowchart for a method of operating a light fixture, according to techniques of the present application.

FIG. 3 illustrates a timing diagram associated with a method for operating a light fixture, according to techniques of the present application.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION OF THE APPLICATION

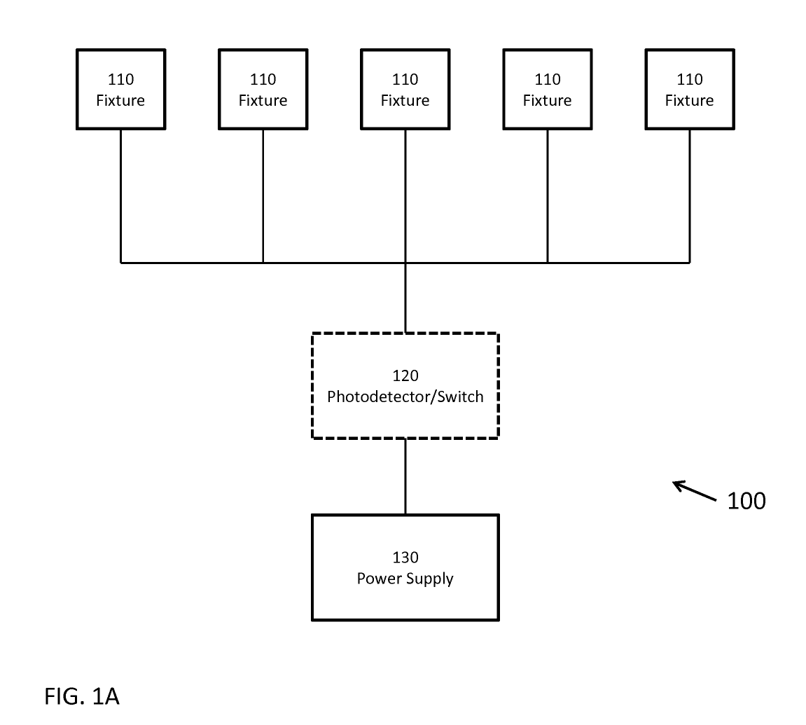

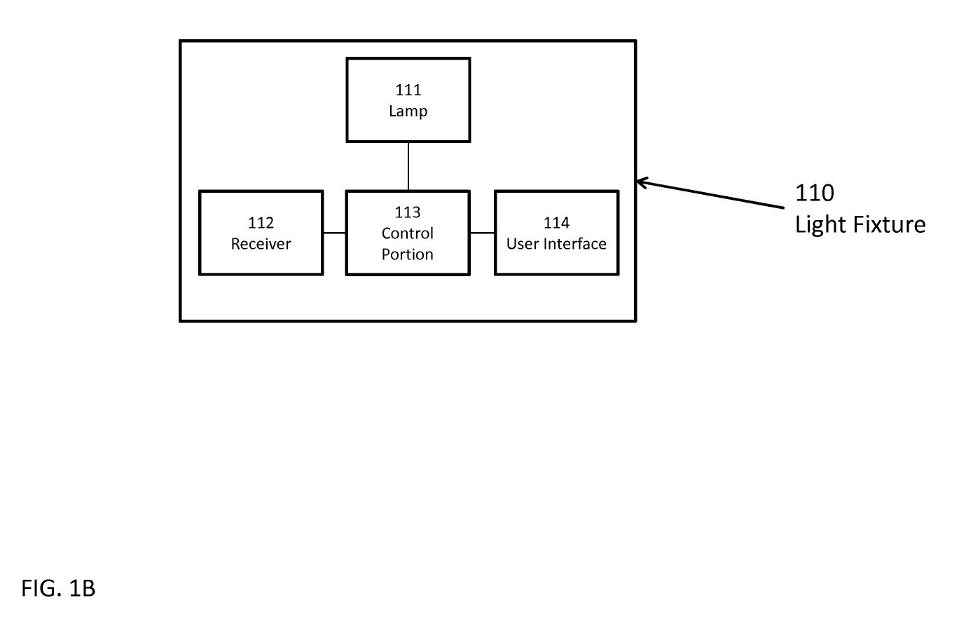

FIGS. 1A and 1B respectively illustrate a lighting system 100 and a light fixture 110 a part thereof, according to techniques of the present application. The system 100 may include a plurality of fixtures 110 and a power supply 130. The lighting system 100 may optionally include a photodetector and/or associated switch 120. The lighting system may also include other components not shown, such as a motion detector, batteries, or the like.

The power supply 130 may be a low-voltage power supply, for example 12 VAC, 12 VDC, 16 VAC, 16 VDC, or the like. The power supply 130 may include a transformer, solar panel, battery, or the like. The power supply 130 may be electrically connected to the power conductors and configured to provide a voltage to the light fixtures 110 through power conductors. When the light fixtures 110 receive the voltage, they may draw current from the power supply. There may be batteries associated with the system 100 to store energy generated by a solar panel. The batteries may be a different component of the system 100 or integrated with one or more illustrated components of the system 100.

The photodetector 120 may cause a voltage to the light fixtures 110 to be switched on and off. The voltage may be switched on when the photodetector 120 senses relatively low ambient light levels. The voltage may be switched off when the photodetector 120 senses relatively high ambient light levels. The light level sensitivity of the photodetector 120 may be adjustable.

A light fixture 110 may include a lamp 111 (optionally mounted in a lamp socket, which is not illustrated), a receiver 112, a control portion 113, and a user interface 114. The lamp 111 may be incandescent, fluorescent, LED, or the like. The lamp 111 may be replaceable or integrated with other portions (for example, control portion 113) of the light fixture 110. The lamp 111 may be electrically connected to the control portion 113. The receiver 112 may be a wireless receiver. The receiver 112 may receive wireless signals, such as infrared or radio signals. The user interface 114 may include one or more buttons, switches, or other structures for facilitating one or more user inputs.

The control portion 113 may supply a voltage to the lamp 111 or lamp socket. If the lamp 111 receives the voltage, it may draw current, for example, from the power supply 130. The supplied voltage may cause the lamp 111 to illuminate. The voltage may be a DC voltage, an AC voltage, or a rapidly pulsed voltage. For example, if the lamp 111 is an LED lamp, it may be possible to rapidly switch the voltage supplied to the lamp 111 and to modulate the switched voltage duty cycle to adjust the effective level of illumination emanating from the lamp 111. The control portion 113 may also communicate with the receiver 112 and/or the user interface 114 to receive signals, such as user input signals.

The control portion 113 may operate the light fixture 110 in two different modes. In the first mode, which may be termed an independent timer mode, the control portion 113 may supply voltage to the lamp 111 or lamp socket according to a timer. The timer may have an ON phase and an OFF phase. The timer may be a 24-hour timer. The timer may be a repeating timer. The ON phase may be approximately 5 hours and the OFF phase may be approximately 19 hours. During the ON phase, voltage may be supplied to the lamp 111 or lamp socket. During the OFF phase, voltage may not be so supplied.

In the independent timer mode, the timer may be initiated when a voltage is initially supplied to the control portion 113 or in response to an initiation signal. The initiation signal may be a user input and may be communicated to the control portion 113 through the user interface 114 or through the receiver 112.

In the second mode, which may be termed a synchronized timer mode, the control portion 113 may supply voltage to the lamp 111 or lamp socket according to a timer. The timer may have an ON phase and an OFF phase. The ON phase may be definite (for example, 5 hours), and the OFF phase may be indefinite. During the ON phase, voltage may be supplied to the lamp 111 or lamp socket. During the OFF phase, voltage may not be so supplied. The timer may not be a repeating timer.

In the synchronized timer mode, a triggering event may cause the timer to start the ON phase. The ON phase may follow substantially immediately after the triggering event or may follow seconds or minutes (for example, 15 minutes) after the triggering event. Accordingly, the timer may start the ON phase shortly after the triggering event. The triggering event may be, for example, when a voltage supplied to the control portion 113 is turned on. The triggering event may be receiving a control signal, such as a wireless control signal received at the receiver 112.

The user interface 114 may facilitate a user to manually select either the independent timer mode or the synchronized timer mode by receiving an input. For example, the user interface 114 may include a three-position slide switch, with the positions being: operate always in independent timer mode (override), operate always in synchronized timer mode (override), and no override. Override inputs may also be received through the receiver 112. The control portion 113 may receive the input from the user interface 114 and/or the receiver 112. The override functionality may execute under the control of the control portion 113, which received the input from the user interface 114 and/or the receiver 112.

If an input indicates operate always in independent timer mode is selected, the time of selection may become the beginning of the independent timer mode cycle. For example, if a user selects the independent timer mode through the user interface 114 at a given time, the independent timer mode may start the ON phase at that given time. If the synchronized timer mode is manually selected, the independent timer may be functionally inoperative.

In an alternative configuration, the control portion 113 may be external to the light fixture 110. One such control portion 113 may be capable of controlling a number of light fixtures 110. In this configuration, the control portion 113 may operate a number of light fixtures 110 in either the independent timer mode or the synchronized timer mode. Similarly, the receiver 112 and user interface may also be external to the light fixture 110 and may operate in conjunction with the control portion 113 to control a number of light fixtures 110.

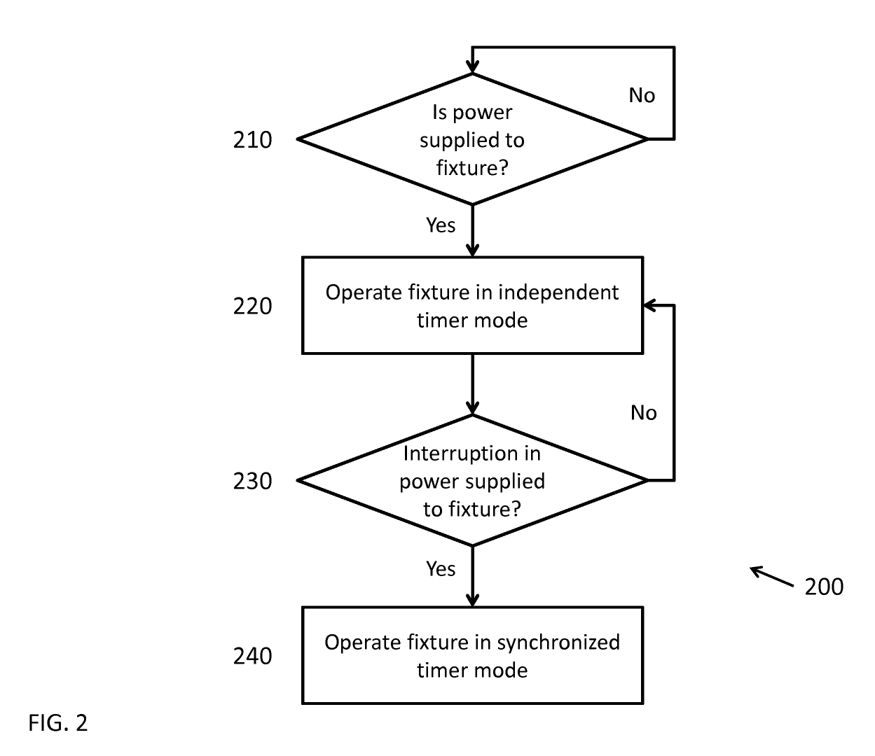

FIG. 2 illustrates a flowchart 200 for a method of operating a light fixture (for example, light fixture 110), according to techniques of the present application. Starting at step 210, if a voltage is supplied to the light fixture then it is operated in independent timer mode at step 220. If there is an interruption in voltage supplied to the light fixture as determined in step 230, then the light fixture is operated in synchronized timer mode at step 240. Otherwise, the light fixture continues to operate in independent timer mode. If there is a momentary power loss (for example, less than 60 seconds), there may be no mode change.

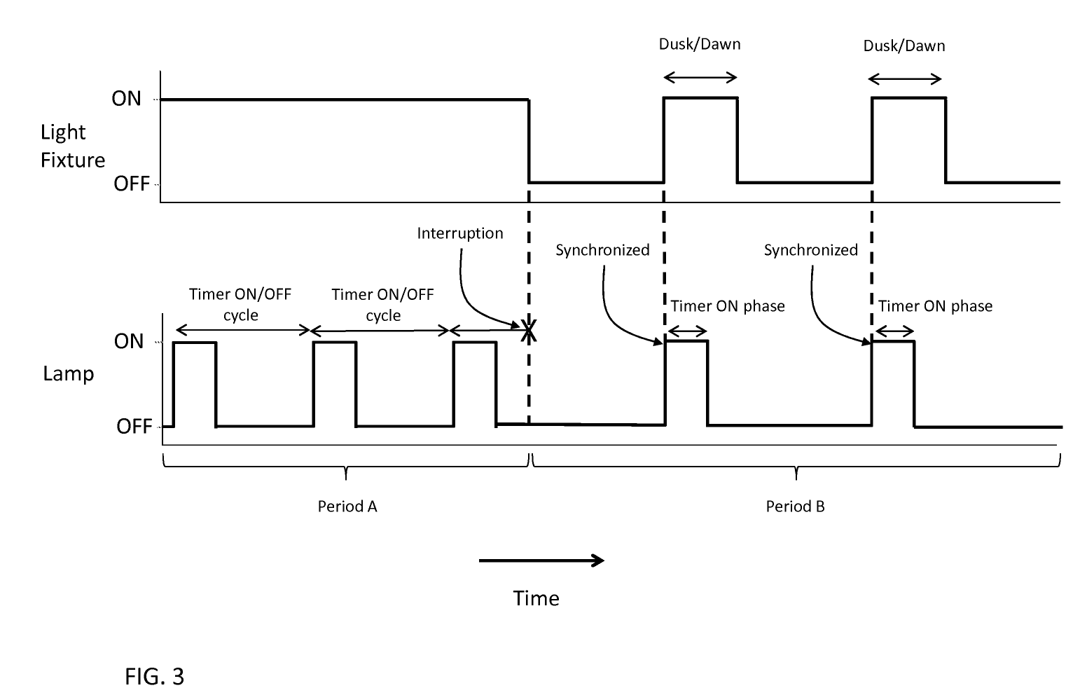

FIG. 3 illustrates a timing diagram which may be illustrative of and may further elaborate on the flowchart shown in FIG. 2. During Period A, the light fixture is on. During Period A, the light fixture is operated in independent timer mode. A repeating timer cycle (for example, a 24-hour repeating timer with an ON phase of 5 hours and an OFF phase of 19 hours) causes a lamp in the fixture to turn on and off. At the end of Period A, there is an interruption in voltage supplied to the light fixture and it turns off. The interruption may be caused by a photodetector detecting a relatively high level of ambient light (for example, daylight) and responsively causing a switch to break an electrical connection between a power supply and the light fixture.

The time subsequent to the interruption is illustrated as Period B. This interruption may be a triggering event that causes the light fixture to subsequently operate in synchronized timer mode. In the synchronized timer mode that operates during Period B, the lamp is switched to its ON phase shortly after a synchronizing event. The synchronizing event may occur when the light fixture turns on. The lamp is in an ON phase for a duration of time and then switched off. This process may be repeated every time there is a synchronizing event. As shown, the light fixture is on between dusk and dawn (for example, in response to being switched on and off by a photodetector).

Thus, as described, it may be possible to automatically or manually adjust the operation of the light fixture depending on whether or not there is a photodetector in the lighting system.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A method for operating a light fixture in a lighting system, the method comprising:
if a voltage is being supplied to the light fixture, operating the light fixture in a first mode;
while operating the light fixture in the first mode, detecting whether there has been an interruption in the voltage supplied to the light fixture;
if there has been an interruption in the voltage supplied to the light fixture, operating the light fixture in a second mode; and
wherein:
the first mode comprises an independent timer mode, and
the second mode comprises a synchronized timer mode.

2. The method of claim 1, wherein the independent timer mode implements a 24-hour repeating timer such that a voltage is supplied to a lamp in the light fixture for a first period of time and a voltage is not supplied to the lamp for a second period of time.

3. The method of claim 2, wherein the first period of time is of lesser duration than the second period of time.

4. The method of claim 3, wherein the first period of time comprises about 5 hours and the second period of time comprises about 19 hours.

5. The method of claim 1, wherein the synchronized timer mode implements a non-repeating timer such that a voltage is supplied to a lamp in the light fixture for a first period of time and a voltage is not supplied to the lamp after the first period of time expires.

6. The method of claim 5, wherein the first period of time begins shortly after a voltage supplied to the light fixture is turned on.

7. The method of claim 5, wherein the first period of time comprises about 5 hours.

8. A light fixture comprising:
a control portion configured to:
operate the light fixture in a first mode if a voltage is being supplied to the control portion,
while operating the light fixture in the first mode, detect whether there has been an interruption in the voltage supplied to the control portion,
if there has been an interruption in the voltage supplied to the control portion, operate the light fixture in a second mode; and
wherein:
the first mode comprises an independent timer mode, and
the second mode comprises a synchronized timer mode.

9. The light fixture of claim 8, further comprising:
a lamp; and
wherein:
the control portion is configured to supply a voltage to the lamp, and
the independent timer mode implements a 24-hour repeating timer such that the control portion supplies a voltage to the lamp for a first period of time and does not supply a voltage to the lamp for a second period of time.

10. The light fixture of claim 9, wherein the first period of time is of lesser duration than the second period of time.

11. The light fixture of claim 10, wherein the first period of time comprises about 5 hours and the second period of time comprises about 19 hours.

12. The light fixture of claim 8, wherein the synchronized timer mode implements a non-repeating timer such that the control portion supplies a voltage to a lamp in the light fixture for a first period of time and does not supply a voltage to the lamp after the first period of time expires.

13. The light fixture of claim 12, wherein the first period of time begins shortly after a voltage supplied to the control portion is turned on.

14. The light fixture of claim 12, wherein the first period of time comprises about 5 hours.

15. The light fixture of claim 8, further comprising:
a user interface configured to receive an input; and
wherein the control portion is further configured to:
receive the input from the user interface, and
responsively operate the lamp in the first mode.

16. The light fixture of claim 8, further comprising:
a user interface configured to receive a input; and
wherein the control portion is further configured to:
receive the input from the user interface, and
responsively operate the lamp in the second mode.

17. A light fixture comprising:
a lamp; and
a control portion configured to:
operate the lamp in a first mode if a voltage is being supplied to the control portion,
while operating the lamp in the first mode, detect whether there has been an interruption in the voltage supplied to the control portion,
if there has been an interruption in the voltage supplied to the control portion, operate the lamp in a second mode; and
wherein:
the first mode comprises an independent timer mode, and
the second mode comprises a synchronized timer mode.

18. The light fixture of claim 17, wherein the independent timer mode implements a 24-hour repeating timer such that the control portion supplies a voltage to the lamp for a first period of time and does not supply a voltage to the lamp for a second period of time.

19. The light fixture of claim 18, wherein the first period of time is of lesser duration than the second period of time.

20. The light fixture of claim 19, wherein the first period of time comprises about 5 hours and the second period of time comprises about 19 hours.

21. The light fixture of claim 17, wherein the synchronized timer mode implements a non-repeating timer such that the control portion supplies a voltage to the lamp for a first period of time and does not supply a voltage to the lamp after the first period of time expires.

22. The light fixture of claim 17, wherein the first period of time begins shortly after a voltage supplied to the control portion is turned on.

23. The light fixture of claim 17, further comprising:
a user interface configured to receive a input; and
wherein the control portion is further configured to:
receive the input from the user interface, and
responsively operate the lamp in the first mode.

24. The light fixture of claim 17, further comprising:
a user interface configured to receive a input; and
wherein the control portion is further configured to:
receive the input from the user interface, and
responsively operate the lamp in the second mode.
